(19) United States
(12) Patent Application Publication
(10) Pub. No.: US 2026/0238973 A1
(43) Pub. Date: Aug. 13, 2026

(54) PROVIDING INFORMATION ABOUT PROVISIONING SERVERS TO USER EQUIPMENT (UE) DURING ONBOARDING PROCEDURES

(71) Applicant: LENOVO (SINGAPORE) PTE. LTD., SINGAPORE (SG)

(72) Inventors: Genadi VELEV, Darmstadt (DE); Roozbeh ATARIUS, La Jolla, CA (US)

(21) Appl. No.: 19/153,489

(22) PCT Filed: Feb. 6, 2024
(86) PCT No.: PCT/IB2024/051099

§ 371 Date: Aug. 4, 2025

Related U.S. Application Data
(60) Provisional application No. 63/483,697, filed on Feb. 7, 2023.

(51) Int. Cl. H04W 4/50; H04W 4/60; H04W 8/20

(52) U.S. Cl. CPC H04W 4/50; H04W 4/60; H04W 8/205

(57) ABSTRACT

Various aspects of the present disclosure relate to transmitting multiple PVS identifiers to a UE, where the PVS identifiers are differentiated from one another, and inform the UE, upon receiving a request to onboard to a desired entity or service, with information that associates or relates the PVS identifiers to a target service, SNPN, or other desired entity. Thus, the network provides a UE with information about how provisioning servers relate to associated localized services or NPNs, which can enable the UE to identify and select the PVS, from multiple available PVSs, which is associated with a desired service of the UE.

### TECHNICAL FIELD

This application claims priority to U.S. Provisional Patent Application No. 63/483,697, filed on Feb. 7, 2023, entitled PROVIDING INFORMATION ABOUT PROVISIONING SERVIERS TO USER EQUIPMENT (UE) DURING ONBOARDING PROCEDURES, which is hereby incorporated by reference in its entirety.

### TECHNICAL FIELD

The present disclosure relates to wireless communications, and more specifically to onboarding devices to local networks.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A Non-Public Network (NPN) facilitates deployment of the 5G access technology for private uses or environments, such as a network dedicated to a single organization, venue, or location. One type of NPN is an SNPN, which is operated by an NPN operator and provides its own network functions or localized services as a local network without utilizing network functions provided by a PLMN, or Public Land Mobile Network.

This local network can be deployed as an NPN, such as an ON-SNPN, or onboarding SNPN, and/or as part of a PLMN. The local network can provide various localized services, such as:

Non-local services: services towards one or more public networks or Internet access services, where there is service level agreement between the local network and a Home PLMN (HPLMN) to offer default IP access using local break out (LBO) and/or home-routed services (e.g., for IMS (IP Multimedia Subsystem) applications);

Local services: services that are enriched compared to services offered via an Internet connection, where end users utilize information/incentives/instructions to seek access to the localized services in a convenient way; and Services to 3rd party service providers: a 3rd party service platform may be operated by an entity/company different from a local/hosting network or PLMN. The 3rd party service providers may offer services either to either the local/hosting network or to HPLMNs (e.g., based on different time or location conditions).

Before a UE can utilize services, such as localized services, of a new network (e.g., a new SNPN), the network may perform an onboarding procedure and provision the UE with subscription information (e.g., subscription identifiers and corresponding credentials, one or more lists of preferred network IDs for network selection, and so on).

Using the subscription information, the network can authorize, authenticate, and/or admit the UE to the network and access the services.

The onboarding procedure can include various processes. For example, onboarding the UE facilitates the UE to access an Onboarding Network (ONN) for the purpose of provisioning the UE with SNPN credentials for primary authentication/authorization and other information, to enable access to a desired SNPN and its onboarding services. The UE can be pre-configured with default UE credentials, which allow the UE to select an SNPN as the ONN, to register with the selected SNPN for onboarding, and/or to establish a secure connection (e.g., a Protocol Data Unit (PDU) Session) with the SNPN. Such an SNPN is referred to as a ON-SNPN. The default UE credentials may be pre-configured in the UE by a Default Credentials Server (DCS), such as a manufacturer or vendor of the device.

Once there is a secure connection between the UE and the ONN (e.g., an ON-SNPN), the UE can utilize a User Plane connection to connect with a provisioning server (PVS). The PVS provisions the UE with desired SNPN credentials and/or other data to enable discovery, (re-)selection, and/or (re-)registration for a desired SNPN.

### SUMMARY

The present disclosure relates to methods, apparatuses, and systems that support transmitting multiple PVS identifiers to a UE, where the PVS identifiers are differentiated from one another, and inform the UE, upon receiving a request to onboard to a desired entity or service, with information that associates or relates the PVS identifiers to a target service, SNPN, or other desired entity. The network can provide a UE with information about how provisioning servers relate to associated localized services or NPNs, which can enable the UE to identify and select the PVS, from multiple available PVSs, which is associated with a desired service of the UE.

Some implementations of the method and apparatuses described herein may further include a UE, comprising: a processor, and a memory coupled with the processor, the processor configured to cause the UE to transmit a request to establish a PDU Session for onboarding to a PVS, receive, in response to the request, a list of one or more PVS identifiers, wherein a PVS identifier is associated with information for an entity for which the PVS provides subscription credentials.

In some implementations of the method and apparatuses described herein, the processor is further configured to cause the UE to select a PVS based on the list of one or more PVS identifiers, and trigger data transmission over a user plane to the selected PVS to acquire provisioning of subscription credentials.

In some implementations of the method and apparatuses described herein, the UE selects the PVS based on a comparison of a desired entity for provisioning and the received information for the entity for which the PVS provides subscription credentials.

In some implementations of the method and apparatuses described herein, the request to establish the PDU Session includes an onboarding indication that indicates a desired entity for provisioning.

In some implementations of the method and apparatuses described herein, entity is an SNPN or localized service.

In some implementations of the method and apparatuses described herein, the list of one or more PVS identifiers is provided within a protocol configuration option container during a successful PDU Session establishment procedure between the UE and a network entity.

Some implementations of the method and apparatuses described herein may further include processor for wireless communication, comprising at least one controller coupled with at least one memory and configured to cause the processor to transmit a request to establish a PDU Session for onboarding to a PVS, and receive, in response to the request, a list of one or more PVS identifiers, wherein a PVS identifier is associated with information for an entity for which the PVS provides subscription credentials.

In some implementations of the method and apparatuses described herein, the controller is further configured to cause the processor to select a PVS based on the list of one or more PVS identifiers, and trigger data transmission over a user plane to a selected PVS to acquire provisioning of subscription credentials for the entity associated with the PVS.

Some implementations of the method and apparatuses described herein may further include a method performed by a UE, the method comprising transmitting a request to establish a PDU Session for onboarding to a PVS and receiving, in response to the request, a list of one or more PVS identifiers, wherein a PVS identifier is associated with information for an entity for which the PVS provides subscription credentials.

In some implementations of the method and apparatuses described herein, the method comprises selecting a PVS based on the list of one or more PVS identifiers and triggering data transmission over a user plane to a selected PVS to acquire provisioning of subscription credentials for the entity associated with the PVS.

Some implementations of the method and apparatuses described herein may further include a network function, comprising: a processor; and a memory coupled with the processor, the processor configured to cause the network function to generate a list of one or more PVS identifiers, wherein a PVS identifier is associated with information for an entity for which a PVS provides subscription credentials and transmit the list of one or more PVS identifiers to a UE.

In some implementations of the method and apparatuses described herein, the processor is further configured to cause the network function to trigger configuration of a UPF to restrict data traffic to entities associated with the list of PVS identifiers.

In some implementations of the method and apparatuses described herein, the configuration of the UPF includes Packet Detection Rules (PDRs) and Forwarding Action Rules (FARs) derived from a list of one or more PVS addresses.

In some implementations of the method and apparatuses described herein, the network entity transmits the list of one or more PVS identifiers via a protocol configuration option container.

In some implementations of the method and apparatuses described herein, the entity is an SNPN or localized service.

In some implementations of the method and apparatuses described herein, the processor is further configured to cause the network entity to receive a request from the UE to establish a PDU Session for onboarding the UE to a PVS.

In some implementations of the method and apparatuses described herein, the request to establish the PDU Session includes an onboarding indication and an indication about a desired entity for provisioning.

In some implementations of the method and apparatuses described herein, the onboarding indication and the indication about the desired entity for provisioning are received in a Nsmf_PDUSession_CreateSMContext Request message from an access and mobility function (AMF) during a PDU Session establishment procedure.

In some implementations of the method and apparatuses described herein, the network entity generates the list of one or more PVS identifiers based on the indication about the desired entity for provisioning.

In some implementations of the method and apparatuses described herein, the network function is an SMF of an SNPN.

Some implementations of the method and apparatuses described herein may further include a method performed by a network function, the method comprising generating a list of one or more PVS identifiers, wherein a PVS identifier is associated with information for an entity for which a PVS provides subscription credentials and transmitting the list of one or more PVS identifiers to a UE.

In some implementations of the method and apparatuses described herein, the method further comprises triggering configuration of a UPF to restrict data traffic to entities associated with the list of PVS identifiers.

### BRIEF DESCRIPTION OF THE DRAWINGS

FIG. 1 illustrates an example of a wireless communications system that supports onboarding devices to local networks in accordance with aspects of the present disclosure.

FIG. 2 illustrates an example of a diagram that supports an architecture for onboarding a UE to an ONN in accordance with aspects of the present disclosure.

FIG. 3 illustrates an example of a diagram that supports a signaling flow for connecting a UE to a target PVS in accordance with aspects of the present disclosure.

FIG. 4 illustrates an example of a diagram that depicts a PCO container carrying a PVS IPv4 address in accordance with aspects of the present disclosure.

FIG. 5 illustrates an example of a diagram that depicts a PCO container carrying a PVS IPv6 address in accordance with aspects of the present disclosure.

FIG. 6 illustrates an example of a diagram that depicts a PCO container carrying a PVS name in accordance with aspects of the present disclosure.

FIG. 7 illustrates an example of a block diagram of a device that supports onboarding a UE to a local network in accordance with aspects of the present disclosure.

FIG. 8 illustrates a flowchart of a method that supports receiving PVS identifiers from a network entity during an onboarding procedure in accordance with aspects of the present disclosure.

FIG. 9 illustrates a flowchart of a method that supports providing PVS identifiers to a UE during an onboarding procedure in accordance with aspects of the present disclosure.

### DETAILED DESCRIPTION

Various issues can arise when a UE attempts to onboard to a desired service provided by a local network, such as an NPN. For example, the UE may receive network credentials from multiple PVSs, but not be able to match the credentials (or the PVSs) to a desired service or services. As another example, the UE may receive certain types of information about multiple PVSs (e.g., IP addresses for the PVSs), but not be able to match the received information to an ON-SNPN or desired services. Such issues can result in unnecessary communications between the UE and various network entities, which can cause inefficiencies and delays during onboarding of the UE and connecting to various services, among other problems.

The technology described herein seeks to remedy such problems by facilitating the transmission of multiple PVS identifiers to a UE, where the PVS identifiers are differentiated from one another. For example, the technology can inform the UE, upon receiving a request to onboard to a desired entity or service, with information that associates or relates the PVS identifiers to a target service, SNPN, or other desired entity.

In doing so, the network provides a UE with information about how provisioning servers relate to associated localized services or NPNs. Such information can enable the UE to identify and select the PVS, from multiple available PVSs, which is associated with a desired service of the UE, among other benefits.

Aspects of the present disclosure are described in the context of a wireless communications system. Aspects of the present disclosure are further illustrated and described with reference to device diagrams and flowcharts.

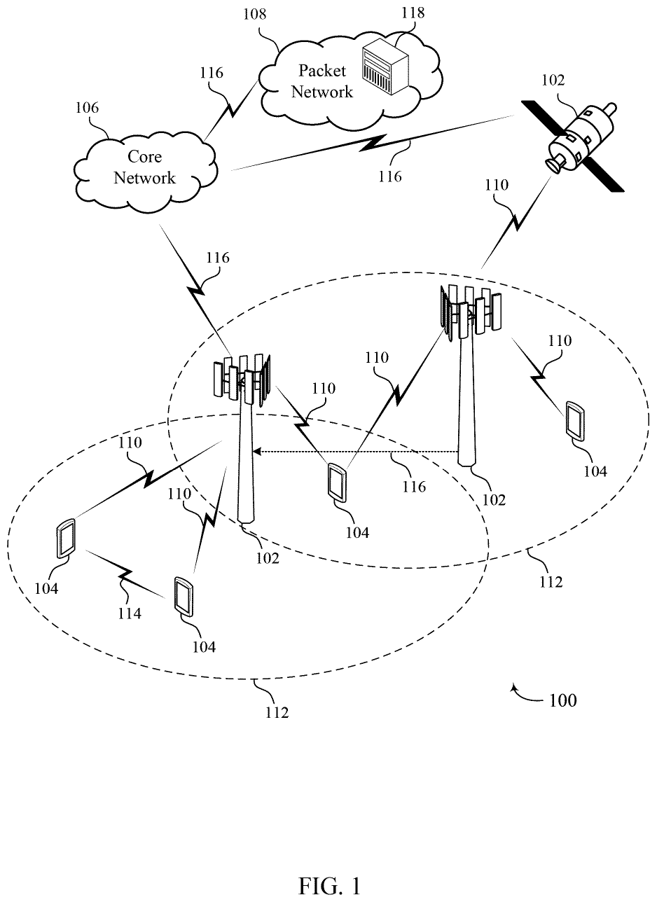

FIG. 1 illustrates an example of a wireless communications system 100 that supports onboarding devices to local networks in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples.

Additionally, or alternatively, the UE 104 may be referred to as an Internet-of-Things (IOT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUsor RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160 Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., λ=0) may be associated with a first subcarrier spacing (e.g., 15 kHz) and a normal cyclic prefix. In some implementations, the first numerology (e.g., λ=0) associated with the first subcarrier spacing (e.g., 15 kHz) may utilize one slot per subframe. A second numerology (e.g., λ=1) may be associated with a second subcarrier spacing (e.g., 30 kHz) and a normal cyclic prefix. A third numerology (e.g., λ=2) may be associated with a third subcarrier spacing (e.g., 60 kHz) and a normal cyclic prefix or an extended cyclic prefix. A fourth numerology (e.g., λ=3) may be associated with a fourth subcarrier spacing (e.g., 120 kHz) and a normal cyclic prefix. A fifth numerology (e.g., λ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., λ=0, λ=1, λ=2, λ=3, λ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively.

Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., λ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FRI may be associated with a first numerology (e.g., μ=0), which includes 15 kHz subcarrier spacing; a second numerology (e.g., λ=1), which includes 30 kHz subcarrier spacing; and a third numerology (e.g., λ=2), which includes 60 kHz subcarrier spacing. FR2 may be associated with one or multiple numerologies (e.g., at least 2 numerologies). For example, FR2 may be associated with a third numerology (e.g., λ=2), which includes 60 kHz subcarrier spacing; and a fourth numerology (e.g., λ=3), which includes 120 kHz subcarrier spacing.

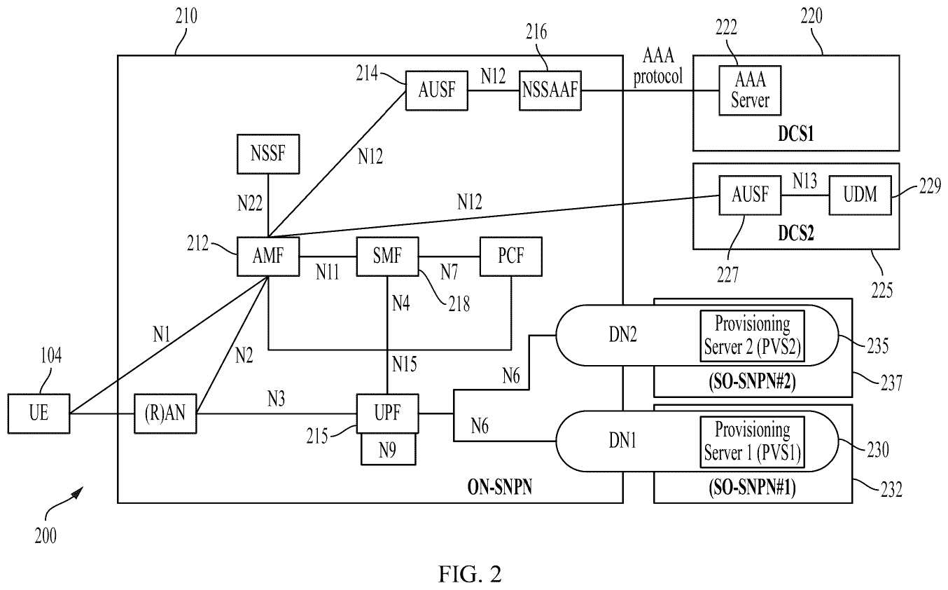

As described herein, the wireless communications system 100 can support the onboarding of a UE to various localized services or SNPNs, by providing the UE with information that ties PVSs (and their PVS identifiers) to the services/networks desired by the UE. FIG. 2 illustrates an example of a diagram 200 that supports an architecture for onboarding a UE to an ONN in accordance with aspects of the present disclosure.

The architecture depicts communications between a UE (e.g., the UE 104), an ONN (e.g., ON-SNPN) 210, a first DCS (e.g., DCS1) 220, a second DCS (e.g., DCS2) 225, and multiple PVSs, such as PVS (e.g., PVS1) 230 and PVS (e.g., PVS2) 235. The ONN 210 can connect to a DCS in a variety of ways.

For example, DCS1 implements an AAA (authentication, authorization, accounting) Server 222 that stores default credentials also stored by the UE 104. An AMF 212 utilizes an N12 reference point to connect to an AUSF (Authentication Server Function) 214 and an NSSAAF (Network Slice-specific and SNPN Authentication and Authorization Function) 216 in the ONN 210. The NSSAAF 216 uses a AAA protocol (e.g., Diameter or Radius) to exchange communications with the AAA server 222 in the DCS domain (in DCS1).

As another example, a DCS, such as DCS2, can implement an AUSF 227 and a Unified Data Manager (UDM) 229. The AMF 212 of the ONN 210 can select the AUSF 227 of the DCS2 and exchange communications over the N12 reference point. The AMF 212 utilizes a Home Network Identifier of an Onboarding SUCI (Subscription Concealed Identifier) of the UE 104 to select a DCS. The ON-SNPN is configured on a per Home Network Identifier basis to determine whether to perform primary authentication with the AUSF 227 and UDM 229 or the AAA server 222. For example, the configuration can be stored in the AMF 212 in the form of Onboarding Configuration Data.

The AMF 212, which supports UE onboarding, is configured with AMF Onboarding Configuration Data. The data can include S-NSSAI (Single-Network Slice Selection Assistance Information) and DNN (Data Network Name) or a configured SMF (Session Management Function), such as SMF 218, for the S-NSSAI and DNN to be used for onboarding. Further, the data can include information to use a local AUSF(s) within the ON-SNPN 210 for onboarding of UEs with a SUCI for a DCS with a AAA Server or for onboarding of UEs in cases where the DCS is not involved during primary authentication.

To support onboarding, the UE 104 is pre-configured with Default UE credentials, and the UE 104 may be pre-configured with ON-SNPN selection information, such as a list of preferred SNPNs. The Default UE credentials can include credentials for primary authentication and, optionally, credentials for secondary authentication (e.g., PDU Session secondary authentication). Upon successful registration for onboarding, the UE 104 receives a registration accept message the allowed NSSAI containing the S-NSSAI of the Onboarding Configuration Data.

The UE 104 establishes a PDU Session using the S-NSSAI. The PDU Session is used for remote provisioning of UEs via the User Plane. The UE attempts to establish a connection to a PVS. The PVS information is either pre-configured in the UE (e.g., UE Configuration Data for User Plane Remote Provisioning, or UPRP) or is provided by the ONN 210. The ONN 210 creates and provides to the UE the UE Configuration Data for User Plane Remote Provisioning (e.g., Configuration Data for UPRP). The Configuration Data for UPRP may take precedence over corresponding configuration data stored in the UE 104. The UE Configuration Data for UPRP includes PVS IP address(es) and/or PVS FQDNs (Fully Qualified Domain Names).

The UE Configuration Data for UPRP is created in the ONN 210 in one of the following ways: (1) the UE Configuration Data for UPRP may be locally configured in the SMF 218 of the ONN 210; or (2) during the UE authentication procedure, the DCS (e.g., DCS 220 or 2250 may provide the UE Configuration Data for UPRP to the AMF 212 in the ON-SNPN. The AMF 212 sends the UE Configuration Data for UPRP in a Nsmf_PDUSession_CreateSMContext Request message to a selected SMF, such as the SMF 218. The SMF 218 sends UE Configuration Data for UPRP to the UE 104 in a PDU Session establishment accept message, such as in a Protocol Configuration Options (PCO) part of a PDU Session establishment response message.

In some cases, the ONN 210 may restrict the PDU Session (established by the UE 104 for provisioning) to be used only for Remote Provisioning of the UE 104. The SMF 218 may configure a UPF (User Plane Function) 215 to filter out data transmissions that do not match the allowed IP addresses indicated in a PVS identifier, e.g., IPv4/v6 addresses of the PVS1 or the PVS2 (e.g., such as when both the PVS1 identifier and the PVS2 identifier were sent to the UE in the UE Configuration Data for UPRP).

As described herein, the technology can solve various problems that may arise during onboarding of the UE 104. In one scenario associated with provisioning localized services to the UE 104, the UE 104 is to be onboarded and provisioned with network credentials for accessing a desired hosting network, which provides localized services). In another scenario, a hosting network may offer multiple localized services, and specific subscription credentials/data may need to be provisioned for each localized service. In one deployment, a first PVS may be used to provision subscription credentials/data for a first localized service and a second PVS may be used to provision subscription credentials/data for a second localized service. Thus, as described herein, the UE 104 may not be aware as to which PVS is used to provision credentials for which localized service.

Another scenario highlights potentials issues with provisioning for a Subscription Owner SNPN (SO-SNPN). As shown, the PVS 230 (e.g., PVS1) may be used to provision subscription credentials/data for a first SNPN (a Subscription Owner SO-SNPN #1 232), and the PVS 235 (e.g., PVS2) may be used to provision subscription credentials/data for a second SNPN (a SO-SNPN #2 237). Issues can arise when the PVS identifiers provided to the UE 104 during the PDU Session establishment procedure contains IP addresses, because the UE 104 may not or cannot know which PVS is used to provision the credentials/data for which SO-SNPN, based only on the IP addresses.

As described herein, the technology enables a network to provide additional information to a UE, to identify a subscription owner behind a PVS identifier, and thus provide information that associates a PVS to credentials and other onboarding information.

In some cases, the UE 104 may provide an indication to the network for a desired service ID for onboarding. The indication can identify that the onboarding is to use local services in the selected ONN (e.g., the ON-SNPN 210), or the onboarding is for a specific SNPN ID, such as a desired network/service ID for which the UE 104 wants to be provisioned with subscription credentials/data.

In one example, the UE 104 sends this indication in a registration request message to the AMF 212, and the AMF 212 stores the indication in the UE context and may forward it to a DCS during a network primary authentication or to the SMF 218 during PDU Session establishment. In another example, the UE 104 sends this indication in a PDU Session establishment request message to the SMF 218, and the SMF 218 stores the indication in the SMF context and uses it to decide which PVS identifier (or identifiers) to send to the UE 104.

The ONN 210 can provide the UE 104 with Configuration Data for UPRP, which contains multiple PVS identifiers. In some embodiments, each PVS identifier is associated with assistance information, which indicates the entity (e.g., SNPN and/or localized service) to which the subscription credentials/data provide access.

For example, the PVS identifier may be associated with information, including:

Information identifying the entity that created (or was the source of) the PVS identifier. For example, the PVS identifier is provided by the DCS domain or the PVS identifier is provided by the ON-SNPN ID;

Information identifying the service that can be accessed/used after the provisioning. For example, the information may include a localized service #1 or a localized service #2 in a specific network ID (e.g., in the SNPN ID). This is applicable when the SNPN provides multiple services, where different PVS entities are used to provision the subscription credentials for each service;

Information identifying the network (or domain) that can be accessed/used after the provisioning, where the information identifies a target network owner of the subscription credentials/data. For example, the information may identify a specific SNPN ID for which the particular PVS provisions the subscription credentials/data, such as SNPN ID #1 (e.g., SO-SNPN #1), SNPN ID #2 (e.g. SO-SNPN #1), or more specifically a service ID in SNPN #3 (e.g., serviceABCD@SNPN-ID#3.3gpp.org), and so on; and other information.

The UE 104 can use the received PVS associated information to determine which PVS identifier to select for provisioning. In other words, the UE 104 utilizes the information provided along with the PVS identifiers to select a PVS identifier that matches the entity (e.g., SNPN or localized service) desired or requested by the UE 104, a user of the UE 104, and/or an upper layer application of the UE 104.

When the UE 104 receives (or stores) multiple PVS identifiers, and the user/application wants to use a specific SNPN/service, the UE 104 inspects the provided mapping information to each PVS identifier and determines the PVS identifier to use when requesting to be provisioned to the desired SNPN/service. For example, the UE 104 can determine that a PVS identifier is used to provision credentials of a local hosting network when the PVS identifier is associated/mapped with/to an ON-SNPN ID (e.g., the same SNPN ID as a selected ON-SNPN).

In some cases, a “PVS identifier” can be used or defined to denote that a PVS may be identified by an IP address or FQDN, such as a PVS IPv4 address, PVS IPv6 address, one or more PVS IPv4/v6 addresses, one or more PVS FQDNs, and so on.

The network can also provide the additional information identifying the target SNPN/service for provisioning (e.g., the SMF 218 transmits or sends the information to the UE 104) to disambiguate situations where multiple PVS servers are used to provision credentials/data for different networks, and the PVS servers are located in a common domain (e.g., of a PVS service provider). In such cases, the PVS servers would have FQDNs or IP addresses that share the same domain name/address of the PVS service provider, but the PVS servers would offer provisioning for different SNPNs/services. Thus, the UE 104, having the additional information, can select the PVS server that matches (or is associated with) the desired service/SNPN.

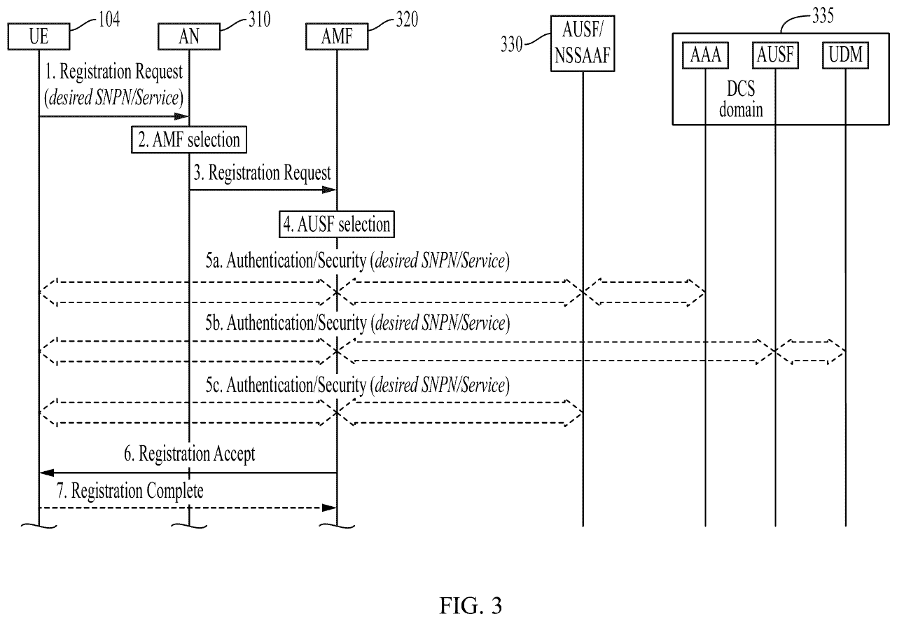

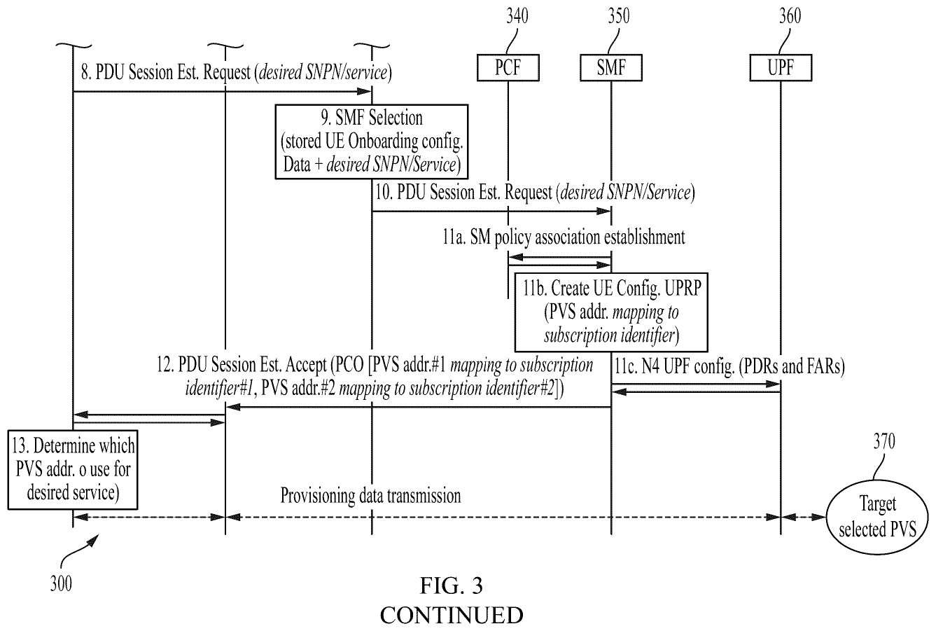

FIG. 3 illustrates an example of a diagram 300 that supports a signaling flow for connecting a UE to a target PVS in accordance with aspects of the present disclosure. The signaling flow includes steps or phases that support the UE 104 registering to or with the ON-SNPN or another ONN (e.g., ONN 210) and the performance of provisioning over a user plane (UP). For example, steps 1-7 are generally associated with a registration procedure for the UE 104, and steps 8-13 are generally associated with a remote provisioning procedure via the UP. The signaling flow is as follows:

Step 1: The UE 104 determines that it needs to register for onboarding in order to be provisioned with subscription credentials/data for a desired network and/or desired service. The UE 104 determines the desired network/service based on input from the user or upper-layer applications. As described herein, the UE 104 selects an SNPN that provides onboarding service and initiates a registration procedure. The UE 104 sets the 5GS Registration Type to the value “SNPN Onboarding,” which indicates to the network (e.g., to an access network, or AN 310, and an AMF 320) that the registration request is for onboarding.

In addition, the UE 104 can include in the Registration Request message an indication that the onboarding is for a for a particular desired network (or desired service) by including the identifier of the network/service. For example, the identifier of the desired network/service can be in the form of an SNPN ID, or “service-ID@SNPN-ID.” The UE 104n may be aware about the desired network/service from upper layers, an application layer, and/or a user indicated preference. Further, the UE 104 includes in an access stratum request message to the AN 310 an indication that the registration is for onboarding.

Step 2: The AN 310 can be a 3GPP specified Radio Access Network, or RAN (e.g., a New Generation RAN (NG-RAN)) or non-3GPP access (e.g., Wi-Fi), which can include a Non-3GPP InterWorking Function (N3IWF) or Trusted Non-3GPP Gateway Function (TNGF). The AN 310 may be configured with an S-NSSAI used for onboarding for the corresponding Tracking Areas where onboarding is enabled. The AN 310 selects an appropriate AMF (e.g., the AMF 320), which serves onboarding registrations.

Step 3: The AN 310 forwards a NAS Registration Request message within a N2 message to the selected AMF 320. The Registration Request message may additionally include an indication, as described herein, that the onboarding is for a for a particular desired network/service and may include the identifier of the network/service (e.g., an SNPN ID).

Step 4: The AMF 320 determines that this UE 104 is not yet registered and triggers primary network authentication and authorization procedures for onboarding services using Default credentials. The AMF 320 may store AMF Onboarding Configuration Data. Such data may include: (a) S-NSSAI and DNN to be used for onboarding and a corresponding configured SMF 350 for the S-NSSAI and DNN used for onboarding; (b) configuration to use a local AUSF 330 within the ON-SNPN for onboarding (e.g., for UEs having a SUCI pointing to a DCS 335 with an AAA Server).

The AMF 320 selects an appropriate AUSF (e.g., the AUSF 330) and triggers the primary network authentication and authorization procedure. If received in step 3, the AMF 320 may store the indication that the onboarding is for a for a particular desired network/service and may include the identifier of the network/service (e.g., the SNPN ID).

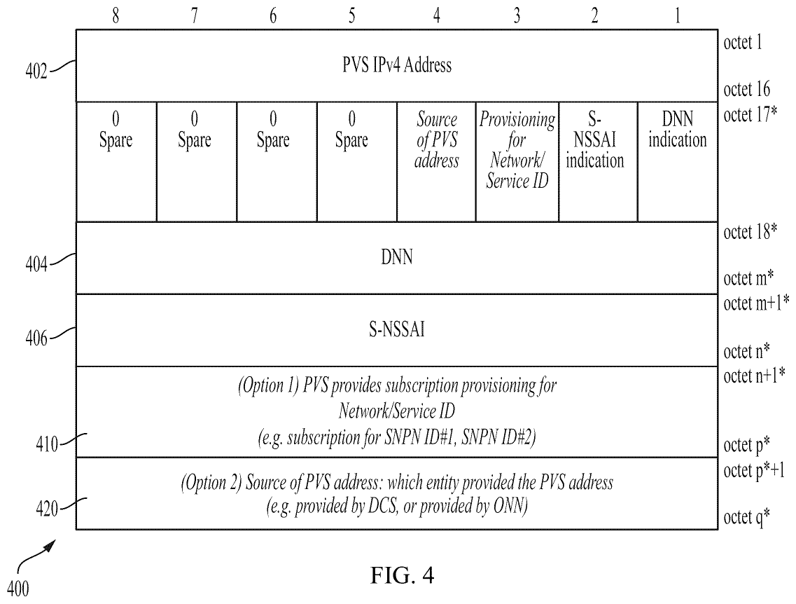

Step 5a: In addition, as described in step 9-1 from FIG. 4.2.2.2.4-1 of TS 23.502, if the AMF 320 has received the identifier of the desired network/service (e.g., the SNPN ID) in step 3, then the AMF 320 may provide the identifier of the desired network/service (e.g., the SNPN ID) to the AUSF 330 in the ON-SNPN domain. During authentication procedure, an AAA Server in the DCS domain 335 may derive and provide one or more PVS identifiers (e.g., PVS FQDN(s) and/or PVS IP address(es)) to the AUSF/NSSAF 330 (e.g., as shown in FIG. 2 the AUSF 214 via the NSSAAF 216). The AUSF 330 then provides the PVS identifier (e.g., PVS FQDN(s) and/or PVS IP address(es)) to the AMF 320. The AAA server may use the desired network/service (e.g., the SNPN ID) as input to determine one or more PVS identifiers to provide to the AMF 320 in the ON-SNPN.

Step 5b: Similar to step 5a, the AMF 320 may provide the identifier of the desired network/service (e.g., the SNPN ID) to the AUSF 330 in the DCS domain 335. The AUSF 330 or UDM of the DCS 335 may use the desired network/service (e.g., the SNPN ID) as input to determine the one or more PVS identifiers to provide to the AMF 320 in the ON-SNPN.

Step 5c: Similar to step 5a, the AMF 320, the AMF 320 may provide the identifier of the desired network/service (e.g., the SNPN ID) to the AUSF 330 in the ON-SNPN domain. The AUSF 330 in the ON-SNPN may use the desired network/service (e.g., the SNPN ID) as input to determine one or more PVS identifiers to provide to the AMF 320.

Step 6: The AMF 320 informs the UE 104 about the result of the registration. If the UE 104 is successfully authenticated, the AMF 320 sends a Registration Accept message to acknowledge that the registration for onboarding is successful. The AMF 320 can further include Allowed NSSAI, including the S-NSSAI from the AMF Onboarding Configuration Data. The AMF 320 stores in the UE context an indication that the 104 UE is registered for SNPN onboarding. Further, the AMF 320 may store the identifier of the desired network/service (e.g., the SNPN ID) sent by the UE 104 and the one or more PVS identifiers sent by the DCS 335.

Step 7: The UE 104 may conditionally send a Registration Complete message.

Step 8: The UE 104 initiates a PDU Session establishment procedure for provisioning. The UE (e.g., the ME part of the UE) may be pre-configured with information for UP Remote Provisioning (e.g., stored together with the Default credentials inserted by the DCS 335). In some cases, the PDU Session establishment request includes the S-NSSAI provided in step 6.

In addition, if the upper layer has provided a desired network (or desired service) to be used for provisioning of credentials, the UE 104 may include in the NAS PDU Session establishment request message an indication that the onboarding is for a for a particular desired network (or desired service). The indication may comprise the identifier of the network/service, where the identifier of the network/service can be in form of an SNPN ID or service-ID@SNPN-ID. The indication can include the desired network/service ID for which the UE 104 desires to be provisioned with subscription credentials/data.

Step 9: The AMF 320 receives the PDU Session establishment request message and based on: (a) the stored UE contexts including the identifier of the desired network/service (e.g., the. SNPN ID) from step 6 and (b) the stored AMF Onboarding Configuration Data, the SMF 350 selects an SMF for the PDU Session.

Step 10: The AMF 320 continues with the PDU Session establishment by forwarding the PDU Session establishment request message from the UE 310 to the SMF 350, where it can be included in the Nsmf_PDUSession_CreateSMContext Request message from the AMF 320 to the SMF 350. If the AMF 320 has stored the identifier of the desired network/service (e.g., the SNPN ID) in the UE context (e.g., as received in step 1), the AMF 320 includes this identifier in the Nsmf_PDUSession_CreateSMContext Request message to the SMF 350. Alternatively, the SMF 350 may receive from the UE 104 an identifier of the desired network/service (e.g., SNPN ID) in the NAS PDU Session establishment request message (e.g., as described in step 8).

Step 11a: The SMF triggers a SM policy association establishment with a PCF 340 (e.g., a SM-PCF) in order to query the policies related to the Onboarding PDU Session. If the PCF 340 stores Onboarding Configuration Data (see TS 23.503 for details), the PCF 340 sends the data to the SMF 350. The Onboarding Configuration Data may contain one or more PVS identifiers (e.g., PVS FQDN(s) and/or PVS IP address(es)). When the UE 104 is provided to the network (e.g., as per step 1 or step 8) the identifier of the desired network/service (e.g., the SNPN ID), the SMF 350 may transmit this identifier to the PCF 340. The PCF 340 uses the identifier of the desired network/service to determine the PVS identifier that serves or is associated with the desired network/service.

Step 11b: Based on: (a) the PVS identifier received from the AMF 320 or the UE 104 in step 10, (b) Onboarding Configuration Data received from the PCF 340, and/or (c) on locally stored Onboarding Configuration Data in the SMF 350, the SMF 350 may create or generate UE Configuration UPRP data to send to the UE 104 (in step 12). The UE configuration UPRP includes a list of one or more PVS identifiers, each associated with information for desired entities (e.g., SNPN(s)/service(s)) for which the PVS provides subscription credentials.

For example, a first PVS identifier may be the same as an identifier received from the AMF 320 in step 10 and a second PVS identifier may be created locally in the SMF 350. The second PVS identifier may be used for provisioning of credentials for the ON-SNPN, and therefore, the SMF 350 may associate the second PVS identifier with the ON-SNPN ID.

As another example, the SMF 350 may determine to use and send to the UE 104 a single PVS identifier that corresponds to the desired network/service received by the SMF 350 in step 10.

Step 11c: The SMF 350 selects an appropriate UPF 360 to serve the user plane. The SMF 350 send, via an N4 interface, a configuration message to the UPF 350 to configure the QoS (Quality of Service) flow for the PDU Session restricted for onboarding. The SMF 350 may configure in the UPF 360 the PDR(s) and the FAR(s) resulting from the one or more PVS identifiers created in step 11b, as well as DNS server IP addresses. In some cases, the UPF 360 can block any traffic that is not from or to the configured PVS identifiers and/or DNS server addresses.

Step 12: The SMF 350 creates and sends a PDU Session Establishment Accept message to the UE 104 via the AMF 320 and the AN 310. The SMF 350 uses the PDU Session Establishment Accept message to send the accept message.

The SMF 350 may provide one or more Protocol Configuration Option (PCO) information (or containers) in the PDU Session establishment accept message. To provide the UE configuration UPRP to the UE 104, the SMF 350 uses a PCO informational element (IE), which may contain a list of one or more PVS identifiers, each associated with information identifying the SNPN(s)/service(s) for which the PVS provides subscription credentials.

The SMF 350 can update, modify, and/or configure a PCO container in a variety of ways to include PVS addresses, as depicted in FIGS. 4-6. FIG. 4 illustrates an example of a diagram 400 that depicts a PCO container carrying a PVS IPv4 address in accordance with aspects of the present disclosure.

The PCO container, or PVS IPv4 Address container, includes contents (e.g., coded following 3GPP TS 24.008) that indicate the PVS IPv4 Address 402 of a PVS and, optionally, a related DNN 404 and S-NSSAI 406 information. Further, the PCO container can include subscription identification information (e.g., provided by the PVS address), such as subscription provisioning for Network/Service ID (e.g., subscription for SNPNID #1, SNPN ID #2) and/or which entity provided the PVS address (e.g., provided by the DCS 220, 225 or the ONN 210).

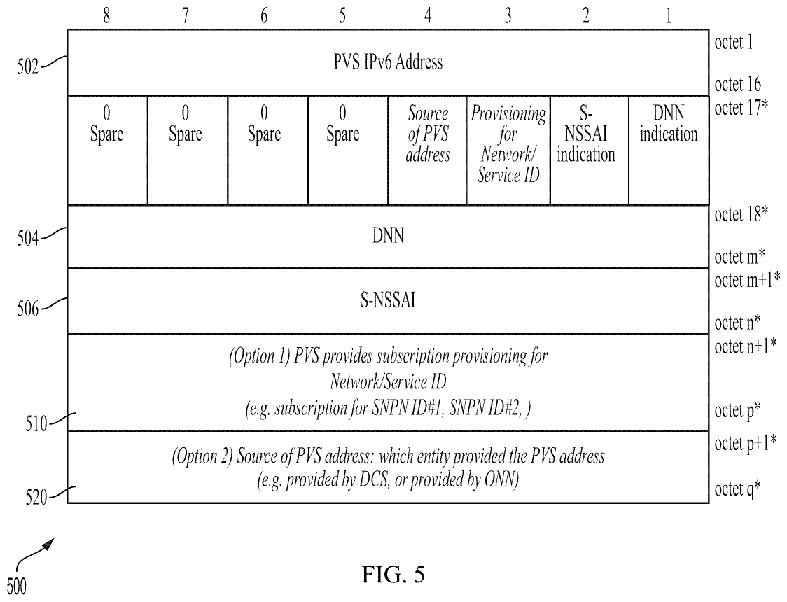

FIG. 5 illustrates an example of a diagram 500 that depicts a PCO container carrying a PVS IPv6 address in accordance with aspects of the present disclosure. The PCO container, or PVS IPv6 Address container, includes contents (e.g., coded following 3GPP TS 24.008) that indicate the PVS IPv4 Address 502 of a PVS and, optionally, a related DNN 504 and S-NSSAI 506 information. Further, the PCO container can include subscription identification information (e.g., provided by the PVS address), such as subscription provisioning for Network/Service ID (e.g., subscription for SNPNID #1, SNPN ID #2) and/or which entity provided the PVS address (e.g., provided by the DCS 220, 225 or the ONN 210).

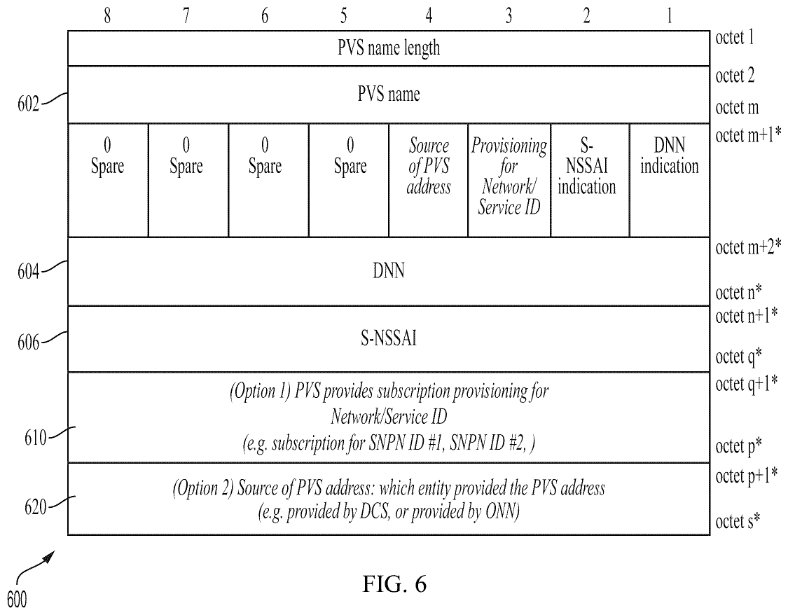

FIG. 6 illustrates an example of a diagram that depicts a PCO container carrying a PVS name in accordance with aspects of the present disclosure. The PCO container, or PVS Name container, includes contents (e.g., coded following 3GPP TS 24.008) that indicate the FDQN information 602 of a PVS and, optionally, a related DNN 604 and S-NSSAI 606 information. Further, the PCO container can include subscription identification information (e.g., provided by the PVS address), such as subscription provisioning for Network/Service ID (e.g., subscription for SNPNID #1, SNPN ID #2) and/or which entity provided the PVS address (e.g., provided by the DCS 220, 225 or the ONN 210).

Returning to FIG. 3, Step 13: The UE 104 receives and stores the UE configuration UPRP information containing one or more PVS identifiers, where each PVS identifier may be associated with information identifying the SNPN(s)/service(s) for which the PVS provides subscription credentials/data.

The UE 104 uses the received information and the locally determined preference (e.g., from a provisioning application in the UE), such as the desired network or service to make a connection. The UE 104 attempts to match the desired network or service to the information identifying the SNPN(s)/service(s) for which the provided PVS identifiers provide subscription credentials/data. The UE 104 (e.g., the provisioning application in the UE) selects the PVS identifier that best matches a desired network or service and triggers a connection establishment over the user plane to the address of the selected PVS identifier, such as to a target selected PVS 370. In one example, if the UE 104 wants to be provisioned with subscription credentials/data to access the ONN to use a localized service, the UE 104 selects a PVS address that is associated with the ONN information. The provisioning application/client in the UE 104 creates or generates a message to request a provisioning over the user plane and the message is sent to the selected PVS destination address.

Thus, as described herein, the network (e.g., via a network entity such as the SMF 218 or 350) provides to the UE 104 one or more PVS identifiers, where each PVS identifier is associated with assistance information identifying the entities (e.g., SNPN(s)/service(s)) for which the PVSs provide subscription credentials/data. This assistance information allows the UE 104 to select the PVS server that would be appropriate, useful, and or associated with the provision of subscription credentials/data for a desired network/service.

For example, with respect to the UE 104, the technology described herein enables (1) the transmitting of an indication (e.g., to an AMF during a Registration procedure) that an onboarding request is for a for a particular desired SNPN/service, (2) the receiving (e.g., from an SMF) a list of one or more PVS identifiers, each one associated with information for SNPN(s)/service(s) for which an associated PVS provides subscription credentials, (3) the triggering of data transmission to a selected PVS over the user plane, where the selected PVS is determined based on the matching of the desired SNPN/service and the associated information for SNPN(s)/service(s) for which the PVS provides subscription credentials, and so on.

As another example, with respect to the SMF 218 or 350, the technology described herein enables (1) the receiving of an indication (e.g., from an AMF) during a PDU Session establishment procedure (e.g., in the Nsmf_PDUSession_CreateSMContext Request message) that an onboarding PDU Session is for a particular desired SNPN/service, (2) the generation of a list of one or more PVS identifiers, each associated with information for SNPN(s)/service(s) for which the PVS provides subscription credentials, (3) the generation of PDRs and FARs according the PVS identifiers and configuring the UPF(s) with such information to restrict data traffic transmissions only to PVS identifiers, and so on.

As a further example, with respect to the AMF 212 or 320, the technology described herein enables (1) the receiving of an indication (e.g., within a Registration Request message) that an onboarding request is for a particular desired SNPN/service, and storing this information in the UE context in the AMF, (2) the transmitting of the received indication to an AUSF during a primary authentication, (3) the transmitting of the received indication to an SMF during a PDU Session establishment procedure, and so on.

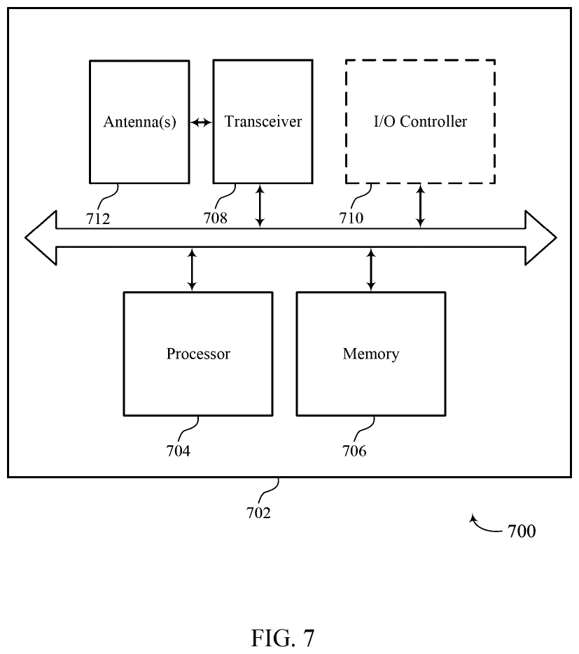

FIG. 7 illustrates an example of a block diagram 700 of a device 702 that supports onboarding devices to local networks in accordance with aspects of the present disclosure. The device 702 may be an example of a network entity 102 or a UE 104 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706).

For example, the processor 704 may support wireless communication at the device 702 in accordance with examples as disclosed herein. The processor 704 may be configured as or otherwise support a means for transmitting a request to establish a PDU Session for onboarding a PVS and receiving, in response to the request, a list of one or more PVS identifiers, wherein a PVS identifier is associated with information for an entity for which the PVS provides subscription credentials.

As another example, the processor 704 may support wireless communication at the device 702 in accordance with examples as disclosed herein. The processor 704 may be configured as or otherwise support a means for generating a list of one or more PVS identifiers, wherein a PVS identifier is associated with information for an entity for which a PVS provides subscription credentials and transmitting the list of one or more PVS identifiers to a UE.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor M04. In some implementations, a user may interact with the device 702 via the I/O controller 710 or via hardware components controlled by the I/O controller 710.

In some implementations, the device 702 may include a single antenna 712.

However, in some other implementations, the device 702 may have more than one antenna 712 (i.e., multiple antennas), including multiple antenna panels or antenna arrays, which may be capable of concurrently transmitting or receiving multiple wireless transmissions.

The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

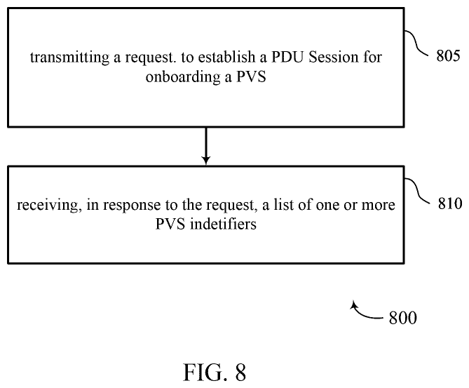

FIG. 8 illustrates a flowchart of a method 800 that supports receiving PVS identifiers from a network entity during an onboarding procedure in accordance with aspects of the present disclosure. The operations of the method 800 may be implemented by a device or its components as described herein. For example, the operations of the method 800 may be performed by the network entity 102 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 805, the method may include transmitting a request to establish a PDU Session for onboarding a PVS. The operations of 805 may be performed in accordance with examples as described herein. In some implementations, aspects of the operations of 805 may be performed by a device as described with reference to FIG. 1.

At 810, the method may include receiving, in response to the request, a list of one or more PVS identifiers, wherein a PVS identifier is associated with information for an entity for which the PVS provides subscription credentials. The operations of 810 may be performed in accordance with examples as described herein. In some implementations, aspects of the operations of 810 may be performed by a device as described with reference to FIG. 1.

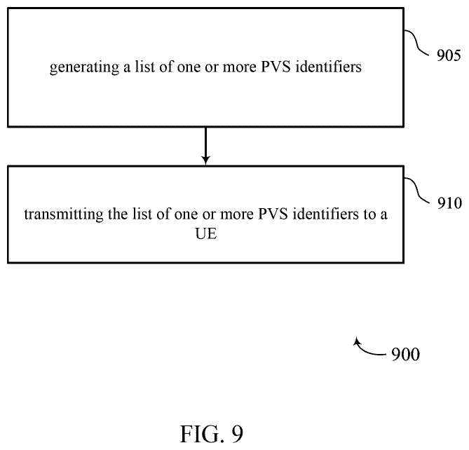

FIG. 9 illustrates a flowchart of a method 900 that supports providing PVS identifiers to a UE during an onboarding procedure in accordance with aspects of the present disclosure. The operations of the method 900 may be implemented by a device or its components as described herein. For example, the operations of the method 900 may be performed by the network entity 102 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 905, the method may include generating a list of one or more PVS identifiers, wherein a PVS identifier is associated with information for an entity for which a PVS provides subscription credentials. The operations of 905 may be performed in accordance with examples as described herein. In some implementations, aspects of the operations of 905 may be performed by a device as described with reference to FIG. 1.

At 910, the method may include transmitting the list of one or more PVS identifiers to a UE. The operations of 910 may be performed in accordance with examples as described herein. In some implementations, aspects of the operations of 910 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”') indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A User equipment (UE) for wireless communication, comprising:
at least one memory; and
at least one processor coupled with the at least one memory and configured to cause the UE to:
transmit a request to establish a Protocol Data Unit (PDU) Session for onboarding to a provisioning server (PVS); and
receive, in response to the request, a list of one or more PVS identifiers,
wherein a PVS identifier in the list of one or more PVS identifiers is associated with information for an entity for which the PVS provides subscription credentials.

2. The UE of claim 1, wherein the at least one processor is further configured to cause the UE to:
select a PVS based on the list of one or more PVS identifiers; and
trigger data transmission over a user plane to the selected PVS to acquire provisioning of subscription credentials.

3. The UE of claim 2, wherein the UE selects the PVS based on a comparison of a desired entity for provisioning and the received information for the entity for which the PVS provides subscription credentials.

4. The UE of claim 1, wherein the request to establish the PDU Session includes an onboarding indication that indicates a desired entity for provisioning.

5. The UE of claim 1, wherein the entity is a Stand-Alone Private Network (SNPN) or localized service.

6. The UE of claim 1, wherein the list of one or more PVS identifiers is provided within a protocol configuration option container during a successful PDU Session establishment procedure between the UE and a network entity.

7. A processor for wireless communication, comprising:
at least one controller coupled with at least one memory and configured to cause the processor to:
transmit a request to establish a Protocol Data Unit (PDU) Session for onboarding to a provisioning server (PVS); and
receive, in response to the request, a list of one or more PVS identifiers,
wherein a PVS identifier in the list of one or more PVS identifiers is associated with information for an entity for which the PVS provides subscription credentials.

8. The processor of claim 7, wherein the at least one controller is further configured to cause the processor to:
select a PVS based on the list of one or more PVS identifiers; and
trigger data transmission over a user plane to a selected PVS to acquire provisioning of subscription credentials for the entity associated with the PVS.

9. A network function for wireless communication, comprising:
at least one memory; and
at least one processor coupled with the at least one memory and configured to cause the network function to:
generate a list of one or more provisioning server (PVS) identifiers,
wherein a PVS identifier in the list of one or more PVS identifiers is associated with information for an entity for which a PVS provides subscription credentials; and
transmit the list of one or more PVS identifiers to a user equipment (UE).

10. The network function of claim 9, wherein the at least one processor is further configured to cause the network function to:
trigger configuration of a user plane function (UPF) to restrict data traffic to entities associated with the list of PVS identifiers.

11. The network function of claim 10, wherein the configuration of the UPF includes Packet Detection Rules (PDRs) and Forwarding Action Rules (FARs) derived from a list of one or more PVS addresses.

12. The network function of claim 9, wherein the network function transmits the list of one or more PVS identifiers via a protocol configuration option container.

13. The network function of claim 9, wherein the network function is a Stand-Alone Private Network (SNPN) or localized service.

14. The network function of claim 9, wherein the at least one processor is further configured to cause the network function to:
receive a request from the UE to establish a Protocol Data Unit (PDU) Session for onboarding the UE to a PVS.

15. The network function of claim 14, wherein the request to establish the PDU Session includes an onboarding indication and an indication about a desired entity for provisioning.

16. The network function of claim 15, wherein the onboarding indication and the indication about the desired entity for provisioning are received in a Nsmf_PDUSession_CreateSMContext Request message from an access and mobility function (AMF) during a PDU Session establishment procedure.

17. The network function of claim 15, wherein the network function generates the list of one or more PVS identifiers based on the indication about the desired entity for provisioning.

18. The network function of claim 9, wherein the network function is a Session Management Function (SMF) of a Stand-Alone Private Network (SNPN).

19. A method performed by a network function, the method comprising:
generating a list of one or more provisioning server (PVS) identifiers,
wherein a PVS identifier in the list of one or more PVS identifiers is associated with information for an entity for which a PVS provides subscription credentials; and
transmitting the list of one or more PVS identifiers to a user equipment (UE).

20. The method of claim 19, further comprising:
triggering configuration of a user plane function (UPF) to restrict data traffic to entities associated with the list of PVS identifiers.
